(19) United States
(12) Patent Application Publication
(10) Pub. No.: US 2008/0181757 A1
(43) Pub. Date: Jul. 31, 2008

(54) BELT-DRIVEN ROBOTIC GRIPPING DEVICE AND METHOD FOR OPERATING

(75) Inventors: Scott A. Wheeler, Ballston Lake, NY (US); Michael F. Bowman, Ballston Lake, NY (US)

Correspondence Address: HESLIN ROTHENBERG FARLEY & MESITI PC, 5 COLUMBIA CIRCLE, ALBANY, NY, 12203, US

(73) Assignee: APPLIED ROBOTICS, INC, Glenville, NY (US)

(21) Appl. No.: 11/936,441

(22) Filed: Nov. 7, 2007

Related U.S. Application Data
(60) Provisional application No. 60/886,775, filed on Jan. 26, 2007.

(51) Int. Cl. B66C 3/14

(52) U.S. Cl. 414/738; 414/815; 901/19; 294/119.1

(57) ABSTRACT

A robotic arm-end gripping device having a belt-driven drive train is provided. The gripping device includes a set of opposing gripping arms, a variable speed motor, a motor controller adapted to control the operation of the variable speed motor, a drive train driven by the variable speed motor, the drive train comprising a drive belt, a plurality of sheaves, and a plurality of belt clamps mounted to the drive belt and operatively connected to the opposing gripping arms, and a robot arm-end interface. The gripping device may include a fail-safe method and apparatus for prevent the dropping of the gripped article. The belt drive and associated controls provide smooth and rapid operation. The gripping device may be adapted to any arm-end tooling.

### CROSS-REFERENCE TO RELATED APPLICATION

This application claims priority from pending U.S. Provisional Patent Application 60/886,775, filed on Jan. 26, 2007, the disclosure of which is included by reference herein in its entirety.

### BACKGROUND OF THE INVENTION

1. Technical Field

The present invention is related to the field of robotic gripping devices. Specifically, aspects of the invention provide gripping devices and methods for operating gripping devices having belt-driven drive mechanisms.

2. Description of Related Art

Gripping devices are common in the robotics industry. These gripping devices typically comprise opposing “fingers” or “hands” on an automated tool that is mounted to a robotic or a gantry-type arm-end. The fingers and hands are adapted to engage an object, for example, an automotive component, and transfer and position the object in a desired location in a desired time. The prior art is replete with gripping device designs and mechanisms that enhance the operation and control of the grippers. However, in many applications, it is often critical that the gripping devices operate smoothly and promptly to ensure the appropriate gripping function is provided and maintained, especially during transport and positioning of the object.

Several prior gripping devices are disclosed in U.S. Pat. No. 6,082,797 of Antonette; U.S. Pat. No. 4,336,926 of Inagaki; U.S. Pat. No. 6,224,123 of Ubele; and U.S. Pat. No. 4,808,898 of Pearson. However, the devices disclosed in these patents are limited when providing the performance desired in today's high-speed, high accuracy manufacturing processes. Aspects of the present invention overcome the disadvantages of theses and other prior art gripping devices and methods for gripping.

### SUMMARY OF THE INVENTION

The present invention comprises a computer controlled, robotic arm-end gripping device having a belt-driven drive mechanism. The arm-end may be used in articulating robots or gantry-type robots or conveyors. Aspects of the invention are uniquely adapted for picking, manipulating, otherwise handling, and placing articles, for example, in an automated factory or other installation. One aspect of the invention is a robotic arm-end gripping device including a set of opposing gripping arms; a variable speed motor; a motor controller adapted to control the operation of the variable speed motor; a drive train driven by the variable speed motor, the drive train comprising a drive belt, a plurality of sheaves, and a plurality of belt clamps mounted to the drive belt and operatively connected to the opposing gripping arms; and a robot arm-end interface. In one aspect, the drive train includes a drive sheave driven by the variable speed motor, and the drive sheave is adapted to drive the drive belt. In one aspect, the gripping device further comprises a feedback loop operatively connected to the motor controller.

Another aspect of the invention is a method of gripping articles, the method including mounting a gripping device to a robotic arm end, the gripping device having a motor and a drive train adapted to operate a pair of opposing gripping arms, the drive train having at least one drive belt; driving the drive belt with a motor; controlling the operation of a motor to regulate the movement of the gripping arms to grip the articles. In one aspect, controlling the operation of the motor comprises controlling the operation of the motor in response to at least one feedback signal from at least one of the motor and the opposing gripping arms.

Another aspect of the invention is a fail safe mechanism for minimizing the dropping of an article retained by a gripping device, the gripping device comprising a pair of opposing arms adapted to engage the article and a drive train adapted to translate the pair of opposing arms, the fail safe mechanism including a motor having a shaft operatively connected to the drive train; and a braking device adapted to engage and prevent rotation of the driven shaft when deactivated; wherein, when deactivated, the braking device prevents rotation of the motor shaft and prevents disengagement of the pair of opposing arms from the article. In one aspect, the drive train comprises a drive belt, and the braking device is adapted to prevent translation of the drive belt.

A still further aspect of the invention is a method for minimizing the dropping of an article retained by a gripping device having a drive train and opposing arms driven by the drive train, the opposing arms adapted to engage the article, the method including energizing a braking device adapted to disengage the drive train when energized; energizing a motor operatively connected to the opposing arms; engaging the article between the opposing arms; and de-energizing the braking device to prevent movement of the drive train and the opposing arms and minimize dropping of the article. In one aspect, the drive chain includes a drive belt, and de-energizing the braking device comprises preventing movement of the drive belt. In another aspect, de-energizing the braking device comprises removing one of electrical, pneumatic, and hydraulic power from the braking device.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a front perspective view of an arm-end gripping device according to one aspect of the invention.

FIG. 2 is a front perspective view of the arm-end gripping device shown in FIG. 1 with the housing cover removed.

FIG. 3 is a top view of the arm-end gripping device shown in FIG. 1 with the housing cover removed.

FIG. 4 is a left side elevation view of the arm-end gripping device shown in FIG. 1 with the housing cover removed.

FIG. 5 is a rear perspective view of the arm-end gripping device shown in FIG. 1 with the housing cover removed.

FIG. 6 is a detailed front perspective view of a drive train that may be used in the arm-end gripping device shown in FIG. 1.

FIG. 7 is a detailed rear perspective view of a drive train that may be used in the arm-end gripping device shown in FIG. 1.

FIG. 8 is a schematic diagram of a control system that may be used to operate the arm-end gripping device shown in FIG. 1.

FIG. 9 is a perspective view of an arm-end gripping device mounting to a robot according to the present invention.

### DETAILED DESCRIPTION

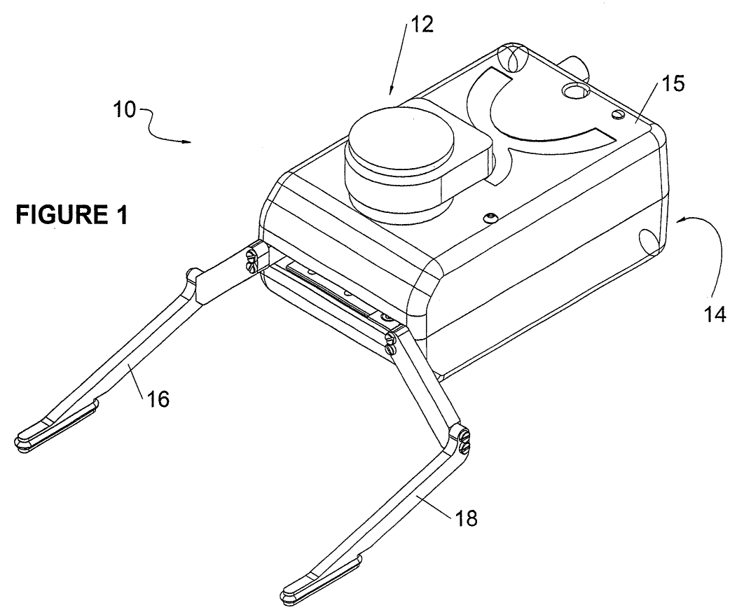

FIG. 1 is a front perspective view of a robotic arm-end gripping device 10, according to one aspect of the invention, mounted to a typical robot arm-end tooling 12, for example, a QuickSTOP 7 arm-end tool provided by Applied Robotics, Inc. of Glenville, N.Y., or its equivalent. As shown, gripping device 10 includes a housing 14 having housing cover 15 and a set of opposing gripping arms 16 and 18. Gripping arms 16 and 18 may be adapted to grip articles (not shown) between gripping arms 16 and 18 or outside of gripping arms 16 and 18 whereby the articles may be picked, transferred, manipulated, otherwise handled, and placed where desired, for example, by the robot arm (not shown) to which gripping device 10 is attached. Gripping arms 16 and 18 may be adapted to grip any individual article or set of articles. For example, gripping arms 16 and 18 may be adapted to grip a container, for instance, a container used in an automated life sciences factory, such as, a container holding biological samples. Gripping arms 16 and 18 may be adapted to grip articles between gripping arms 16 and 18 (for example, for “external grip”) or grip articles outside gripping arms 16 and 18 (for example, for “internal grip”), where gripping arms 16 and 18 push outward to contact the article. In one aspect of the invention, arms 16 and 18 may be adapted to separate surfaces, for example, arms 16 and 18 may be adapted to opening bags or other containers. Gripping arms 16 and 18 may typically provide a gripping or separating force of at least 5 pounds, but may provide a gripping force of 10 pounds or more, though aspects of the invention may be scaled up or down for a broad range of applications. In one aspect, the gripping or separating force provided by gripping arms 16 and 18 may be variable, for example, the force may vary from about 0 to about 5 pounds. Gripping arms 16 and 18 may typically have elastomeric gripping surfaces 17, for example, rubber pads or tips, that facilitate grasping and retention of the article being handled. Gripping arms 16 and 18 may also be swivel or pivot-tip gripping arms. According to aspects of the invention, the motion of gripping arms 16 and 18 are controlled by a motor, drive train, and controller (all not shown) contained in housing 14.

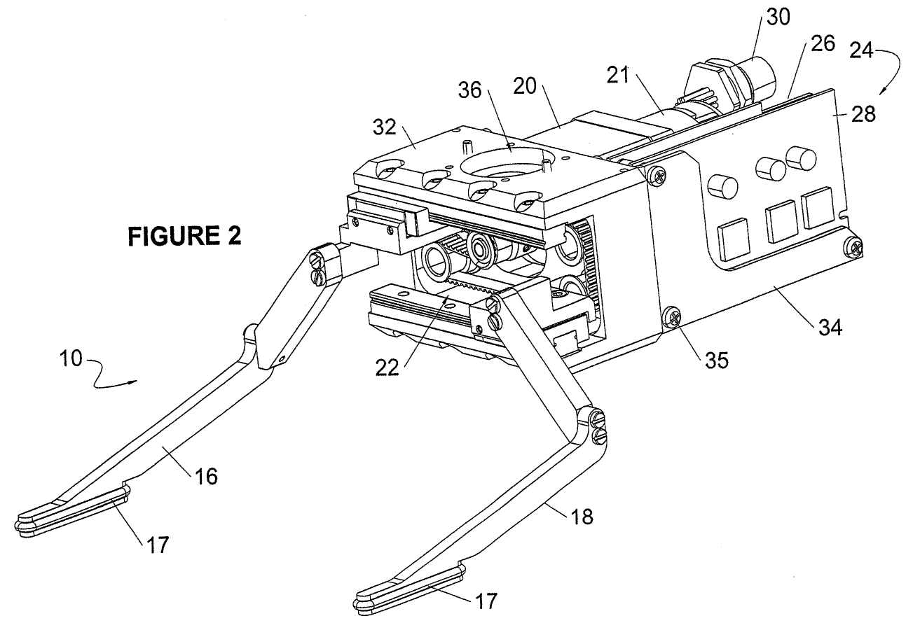

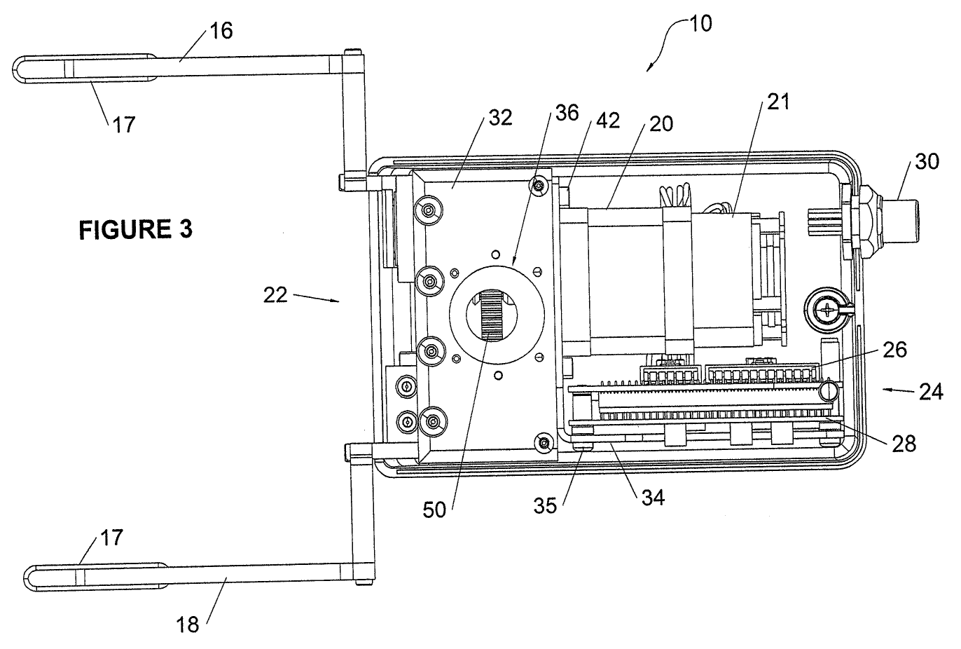

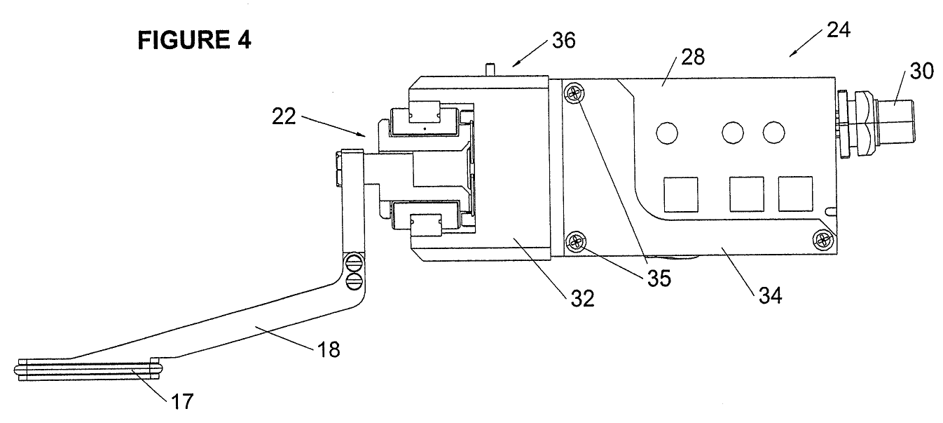

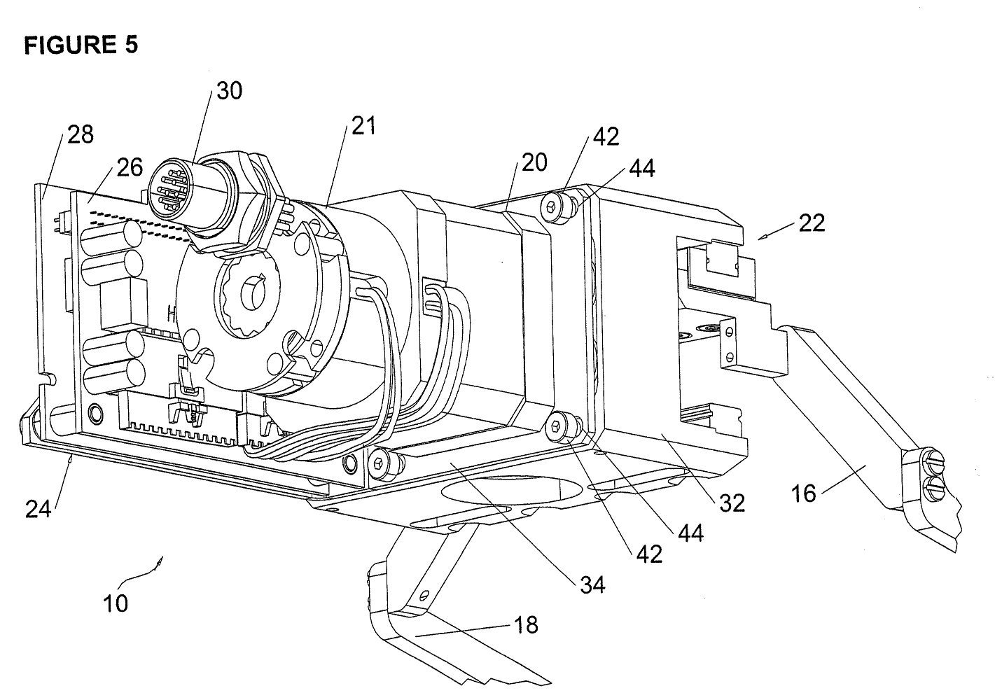

FIG. 2 is a front perspective view of the arm-end gripping device 10 shown in FIG. 1 with the housing cover 15 removed. FIG. 3 is a top view of the arm-end gripping device 10 shown in FIG. 1 with the housing cover 15 removed and FIG. 4 is a left side elevation view of the arm-end gripping device 10 shown in FIG. 1 with the housing cover 15 removed. FIG. 5 is a rear perspective view of the arm-end gripping device 10 shown in FIG. 1 with the housing cover 15 removed. As shown in FIGS. 2-5, device 10 includes a motor 20, which drives a drive train 22 operatively connected to gripping arms 16 and 18. Motor 20 may typically be a variable speed motor, for example, a stepper motor, having a rating of at least 0.36 Newton-meters [N-m]. In one aspect, motor 20 may be a NEMA size 17 mounting, step size 0.9 degrees, stepper motor, for example, model number 4209M-SID-XX stepper motor provided by Lin Engineering, of Santa Clara, Calif., or its equivalent.

The operation of motor 20 is controlled by motor controller 24, for example, motor controller 24 typically comprises one, but may include two, circuit boards 26 and 28, for example, motor controller board provided by Trinamic, or its equivalent. Controller 24 may be programmed with subroutines, for example, subroutines instructing motor 20 to rotate and grip articles, release articles, or return gripping arms 16 and 18 to a home position. In one aspect, providing controller 24 with internal algorithms, for example, instead of providing motor 20 with instructions externally, makes device 10 easier to use than prior art gripping devices. Device 10 includes an electrical interface 30 for providing electrical power and/or control signals to device 10, for example, a Turck 12-pin male connector, or its equivalent. Electrical interface 30 may provide external power and may include a simple serial interface (RS 232) that receives operational characters from an external controller (not shown) or master robot (not shown), while also providing a conduit for forwarding operational data or performance status of gripper device 10 to the external interface or controller. Electrical interface 30 may also provide discrete input and output signals, for example, for initiating motions and for signaling status of motions, respectively.

As shown in FIG. 2-5, device 10 includes a main housing structure (or “backbone”) 32 and a bracket 34 mounted to housing structure 32, for example, by means of a plurality of fasteners. Drive train 22 is typically mounted in housing structure 32 and motor 20 and motor controller 24 are typically mounted in bracket 34, for example, controller circumvent boards may be mounted to bracket 34 by means of a plurality of screws 35. Main housing structure 32 typically includes a tool interface 36 having appropriate threaded holes and one or more dowel pins, for example, an interface adapted to receive a QuickSTOP 7 arm-end provided by Applied Robotics, Inc., or its equivalent. Structure 32 and bracket 34 may be metallic or non-metallic. For example, structure 32 and bracket 34 may be fabricated from aluminum; for instance, structure 32 and bracket 34 may be machined from a block of aluminum or cast from aluminum and final machined. Structure 32 and bracket 34 may also be fabricated from a plastic; for instance, structure 32 and bracket 34 may be injection molded from a polymer.

Device 10 may also include a braking device 21 adapted to engage and disengage the drive train 22. Braking device 21 may also be controlled by controller 24, energizing braking device 21 to release braking device 21 to permit motion and de-energizing braking device 21 to engage drive train 22 and stop the movement of gripping arms 16 and 18, for example, in a desired position. When gripping arms 16 and 18 comprise flexible gripping arms, for example, arms that typically require the maintenance of a gripping force to ensure engagement with an article, braking device 21 may provide sufficient holding force to maintain the desired gripping force in flexible gripping 16 and 18 and prevent flexible gripping arms 16 and 18 from “unspringing” and releasing the article. The gripping force may be maintained by braking device 21 even when electrical power to device 10 is lost. Braking device 21 may comprise a “fail safe” braking device, for example, a braking device that stops the rotation of motor 20 when electrical power is lost to device 10. In one aspect, braking device 21 may be a spring-set, electromagnetic, fail safe braking device provided by Danaher, for example, model FSB-17-24-MO5-S, or its equivalent.

As shown in FIG. 5, motor 20 and braking device 21 may be mounted to bracket 34, for example, by means of mechanical fasteners, and bracket 34 may be mounted to main housing structure 32 by means of a plurality of screws 42, for example, 3 mm pressure socket shoulder screws. In one aspect of the invention, bracket 34 includes a plurality of slotted holes 44 through which screws 42 adjustably mount bracket 34 (and motor 20) to main housing structure 32. Slotted holes 44 permit the adjustment of the alignment of mounting bracket 34 and motor 20 whereby the tension in the drive belt 50 (see below) may be varied.

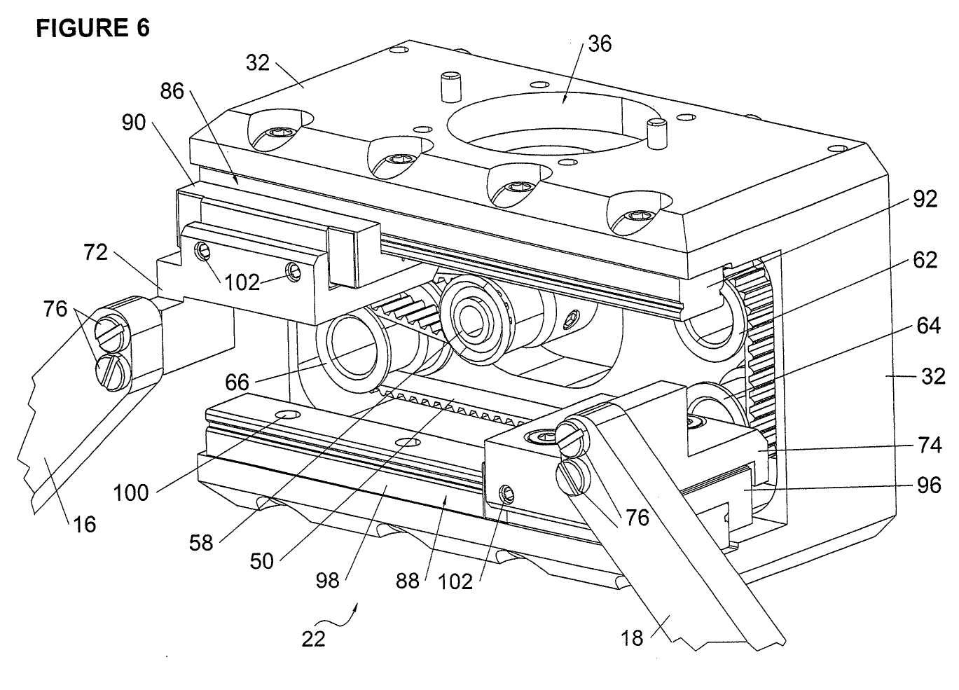

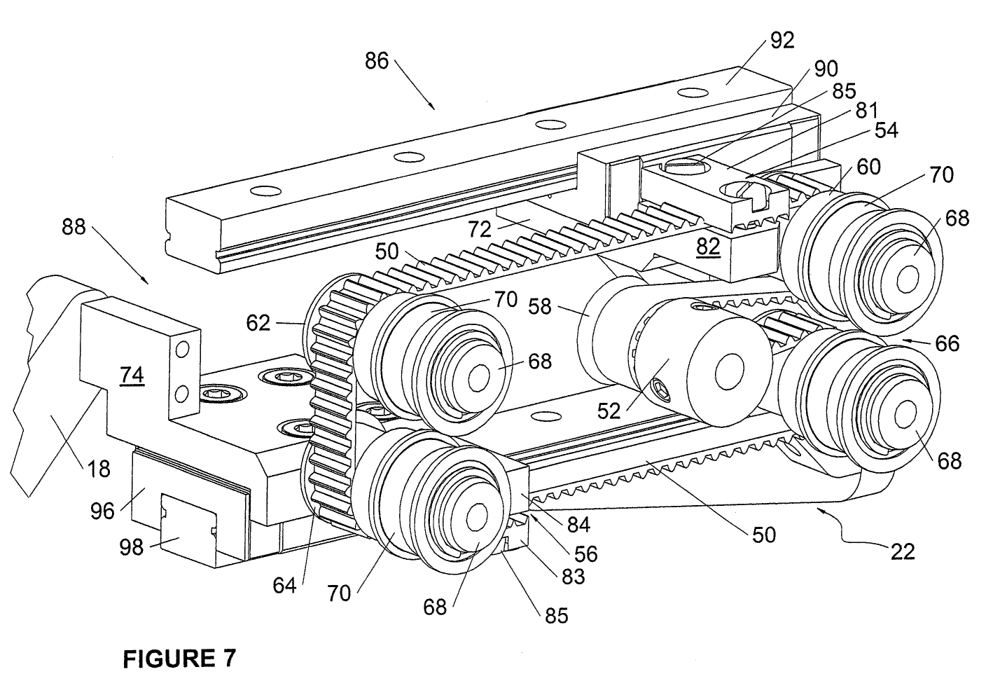

FIG. 6 is a detailed front perspective view of a drive train 22 that may be used in the arm-end gripping device 10 shown in FIG. 1. FIG. 7 is a detailed rear perspective view of drive train 22 in which main housing structure 32 has been removed to better illustrate details of this aspect of the invention. As shown in FIGS. 6 and 7, drive train 22 includes a continuous belt 50 driven by motor 20 and braking device 21 (both not shown) via drive pulley 52 to translate belt clamps 54 and 56, which are operatively connected to gripper arms 16 and 18, respectively. According to aspects of the invention, any type of conventional belt may be used in drive train 22, for example, a flat belt, a v-belt, or a synchronous timing belt, among others; however, as shown in FIGS. 6 and 7, belt 50 may be a toothed belt, for example, a polyurethane toothed belt with aramid fiber reinforcement, for example, with DuPont Kevlar® aramid fiber reinforcement, though other types of toothed belts may be used. In one aspect, a synchronous toothed timing belt provided by Misumi, USA may be used for belt 50, for example, a belt having model number 2SM and part number HTUN24052M-60, or its equivalent.

As shown in FIG. 7, in one aspect, drive pulley 52 includes a drive sheave or pulley shaft 58, for example, a toothed sheave adapted to engage toothed belt 50. Belt 50 engages idler sheaves 60, 62, 64, and 66. Idler sheaves 60, 62, 64, and 66 may be toothed like drive sheave 58 or, as shown in FIGS. 6 and 7, may comprise smooth sheaves. Sheaves 60, 62, 64, and 66 typically include mounting shafts 68. Idler sheaves 60, 62, 64, and 66 are typically mounted by means of their shafts 68 in bearings 70. Bearings 70 may be any conventional journal, roller, needle, or ball bearing; for example, bearings 70 may be ABEC 5 shoulder ball bearings. Bearings 70 are mounted in main housing structure 32, for example, bearings 70 may be press fit into openings in main housing 32. The shafts 68 of idler sheaves 60, 62, 64, and 66 may be retained in bearings 70 by means of a retaining ring (not shown).

Belt clamps 54 and 56 are mounted to belt 50 and translate with the movement of belt 50. Belt clamps 54 and 56 are also mounted to gripper arm mounting blocks 72 and 74, respectively. Gripper arm 16 is mounted to mounting block 72 and gripper arm 18 is mounted to mounting block 74, for example, by means of screws 76, which may be shoulder screws adapted for rapid and easy mounting and dismounting of gripper arms 16 and 18. Screws 76 also provide an accurate means for maintaining the position of gripping arms 16 and 18 should gripper arms 16 and 18 need to be replaced. Belt clamps 54 and 56 typically include matching blocks 81 and 82 and 83 and 84, respectively, which are held together by one or more screws 85. As shown, blocks 81 and 83 may include projections and/or recesses adapted to engage the teeth on belt 50. As also shown in FIG. 7, block 82 of belt clamp 54 is mounted to mounting block 72 and block 84 of belt clamp 86 is mounted to mounting block 74.

As shown in FIGS. 5 and 6, gripper arm mounting blocks 72 and 74 are slidably mounted to main housing structure 32 to permit translation of gripper arms 16 and 18 with the movement of belt clamps 54 and 56. In one aspect, gripper arm mounting blocks 72 and 74 may be mounted on linear bearings 86 and 88 mounted to main housing structure 32. For example, linear bearings 86 and 88 may be C-sleeve linear motion rolling guides provided by IKO, or their equivalent. As shown in FIG. 5, mounting block 72 may be mounted to bearing slider 90, which translates on bearing rail 92. Bearing rail 92 may be mounted on main housing 32, for example, by means of a plurality of fasteners (not shown). Similarly, mounting block 74 may be mounted to bearing slider 96, which translates on bearing rail 98. Bearing rail 98 may be mounted on main housing 32, for example, by means of a plurality of fasteners 100. Gripper arm mounting blocks 72 and 74 may be mounted to bearing sliders 90 and 96 by means of a plurality of screws 102, for example, a plurality of set screws that facilitate assembly of the blocks 72 and 74 on sliders 90 and 96 while providing a means for adjustment of their alignment.

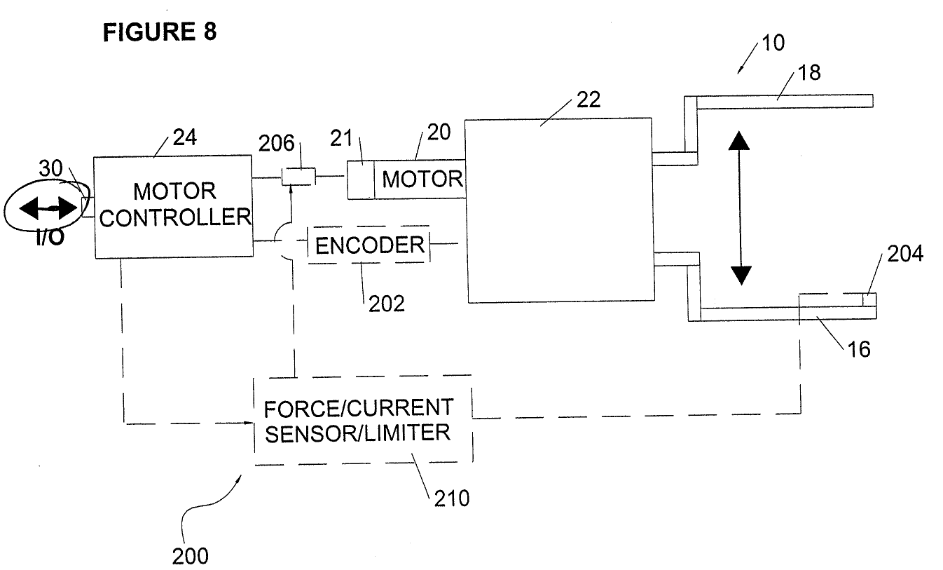

FIG. 8 is a schematic diagram of a control system 200 that may be used to operate the arm-end gripping device 10 shown in FIG. 1. Control system 200 includes gripper arms 16 and 18, motor 20, braking device 21, drive train 22, and motor controller 24 described above. As shown, motor controller 24 typically receives power, discrete control signals, and operational characters from an external controller or master robot (not shown) via connector 30, for example, an RS 232 signal, an RS 422 signal, or a USB bus. Motion controller 24 is adapted to perform all communications with external systems and controls the operation of gripping device 10. Controller 24 may comprise microcomputer and motor drive electronics. Controller 24 may also include some form of memory to store data and/or programs. Controller 24 controls the operation of motor 20 that drives drive train 22 and controls the operation of braking device 21 to operate gripper arms 16 and 18.

In one aspect of the invention, a feedback loop 210 may be provided between from the drive train 22 or arms 16 and 18 to controller 24. The feedback to controller 24 may comprise a speed in the drive train, a force from gripper arms 16 and 18, or a current draw from motor 20. As shown in FIG. 8, feedback from drive train 22 may comprise the speed of one or more drive train components as detected by encoder 202, for example, an encoder adapted to detect the speed of belt 50 or an idler sheave in drive train 22. A force feedback to controller 24 may be obtained from one or more force or pressure sensors 204 mounted to detect the force or pressure exerted by gripping arms 16 and/or 18. Motion controller 24 may be programmed to limit the gripping force exerted by gripping arms 16 and 18. A current feedback may be provided by current detector and/or limiter 206 adapted to detect the current drawn by motor 20, which can also be used as an indication of the force exerted by gripping arms 16 and 18.

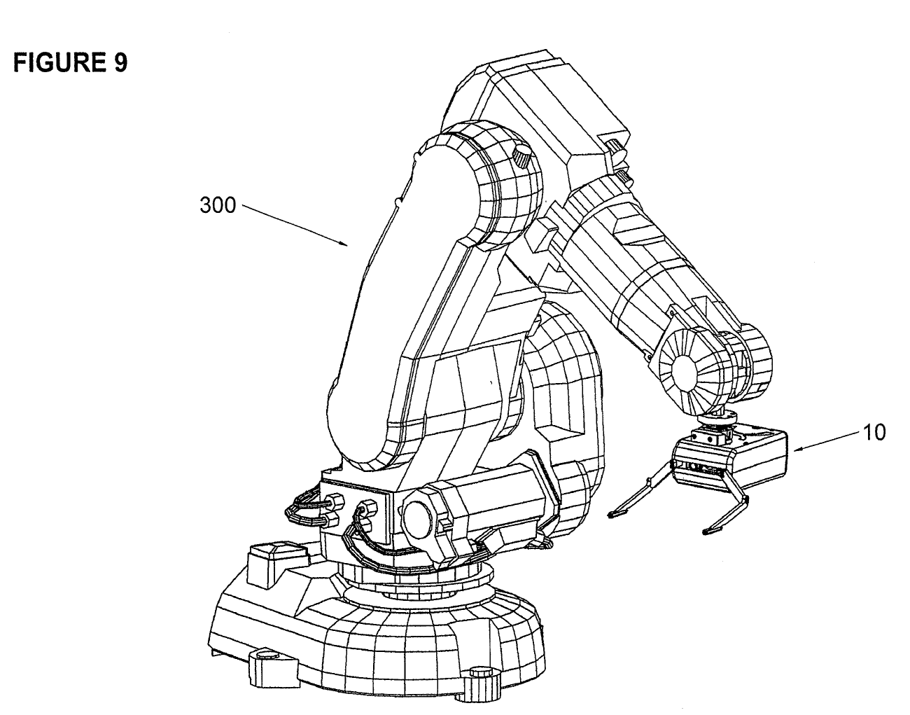

FIG. 9 is a perspective view of an arm-end gripping device 10 mounting to a robot 300 according to the present invention. Robot 300 may comprise a RV-3SJ robot provided by Mitsubishi; however, gripping device 10 may be mounted any appropriate robotic manipulator.

According to one aspect of the invention, the presence of a controller 24 in housing 14 allows the operator to incorporate at least some intelligence within gripping device 10 to operate the gripper function without significant input through a user or external controller. By including motion controller 24 and appropriate programs within gripping device 10, the interface to the controlling device (not shown) may provide a plurality of discrete signals, for example, five or more, to initiate and perform desired functions. Gripping device 10 may be an essentially stand-alone intelligent device (having memory to store a number of programs), and may be an internally controlled electronic gripping device which can start by itself with little or no additional intelligence required. Programs may be initially loaded into motion controller 24 using a serial data link.

In other aspects of the invention, gripping device 10 may also include a feedback monitoring and control system to monitor the position/location of gripper arms 16 and 18. For example, an encoder or position sensor may provide feedback on the position of drive shaft of motor 20, the position of gripper arms 16 and 18, or the position of gripper arm mounting blocks 72 and 74, among other points of detection, to sense position, velocity, force, or torque, and allow appropriate adjustment to operation or performance. Gripping device 10 may also limit the closure or opening force by sensing force at the gripping arms 16 and 18, or nearby, to limit motor current by using analog processing. In addition, gripping device 10 may include an internal “stand-alone” circuit, independent of the motion controller, to limit gripping force. Gripping device 10 may also include an internal homing routine.

Another aspect of the invention includes a fail-safe method and mechanism that minimize or prevent the likelihood of “dropping” an object. Typical prior art gripping devices, that is, devices operated, for example, electrically or pneumatically, operate by applying electrical power or air pressure to the corresponding gripping mechanism to grip an object. Such prior art devices typically continue to apply electrical power or air pressure during the entire time an object is gripped. In such devices, since power is required to grip an object, loss of power can cause such prior art devices to undesirably disengage or “drop” an object when power is lost, even for very brief periods. Aspects of the present invention avoid this disadvantage of prior art gripping devices.

According to one aspect, gripping device 10 may include a motor 20 adapted to translate arms 16 and 18 to engage an object (not shown) and a braking device 21 adapted to prevent rotation of drive pulley 52 when power is lost to braking device 21, that is, braking device 21 may comprise a “fail safe” braking device. For example, in one aspect, when braking device 21 is de-energized, that is, “off,” braking device 21 engages or “locks” the motor shaft (not shown) of motor 20 wherein drive pulley 52 is also “locked” from rotation. When braking device 21 is energized, that is, “on,” braking device 21 disengages or “unlocks” the motor shaft of motor 20, and drive pulley 52 is allowed to rotate. The braking device may be powered by any conventional power source, including electrical, pneumatic, and hydraulic power.

According to one aspect, an object is gripped by gripping device 10 by energizing motor 20 and translating gripper arms 16 and 18 to engage the object. However, once the object is engaged by arms 16 and 18, in one aspect, braking device 21 may be de-energized whereby braking device 21 prevents drive pulley 52 from rotating, and effectively “locking up” drive train 22 and effectively preventing arms 16 and 18 from dropping the object. For example, when motor 20 is de-energized, braking device 21 may provide the only means by which the object is gripped. That is, in one aspect, a “fail safe” gripping apparatus and method are provided to minimize or prevent the dropping of objects. According to one aspect of the invention, if power is lost, for whatever reason, the object gripped by gripping device 10 will not drop an object held between gripping arms 16 and 18.

In one aspect of the invention, gripping device 10 may be adapted to receive mechanical power from the robot to which gripping device 10 is mounted. For example, in one aspect, a separate electric motor for driving gripping device 10 may not be required to operate gripping device 10. One source of mechanical power that may be used to drive gripping device 10 may be one of the plurality of motors typically provided with robots. A typical multiple axis robot includes multiple electric motors to control the operation of the robot about the multiple axes. For example, a 5-axis robotic arm end having 5 electric motors may only use 4 of the motors to operate the arm end. According to one aspect of the invention the fifth or “last axis” electric motor may use to drive drive train 22 in gripping device 10. Access to drive train 22 may be provided by a coupling adapted to receive input from the unused axis motor and transmit mechanical power to drive train 22, for example, by means of gears, belts, pulleys, or similar drive hardware. The operation of drive train 22 may be governed by a motor, a brake, and/or a controller associated with the unused axis motor. In one aspect, the robot controller and the robot programming software may be used to operate and control drive train 22. This mode of operation can simplify the integration and operation of gripping device 10 with a robot arm end.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A robotic arm-end gripping device comprising:
a set of opposing gripping arms;
a variable speed motor;
a motor controller adapted to control the operation of the variable speed motor;
a drive train driven by the variable speed motor, the drive train comprising a drive belt, a plurality of sheaves, and a plurality of belt clamps mounted to the drive belt and operatively connected to the opposing gripping arms; and
a robot arm-end interface.

2. The gripping device as recited in claim 1, wherein the drive train comprises a drive sheave driven by the variable speed motor, the drive sheave adapted to drive the drive belt.

3. The gripping device as recited in claim 1, wherein the plurality of sheaves comprise a plurality of idler sheaves adapted to be driven by the drive belt.

4. The gripping device as recited in claim 1, wherein the drive belt comprises a toothed drive belt.

5. The gripping device as recited in claim 1, wherein the gripping device further comprises a feedback loop operatively connected to the motor controller.

6. The gripping device as recited in claim 1, wherein the belt clamps are operatively connected to the opposing gripping arms by means of gripper arm mounting blocks.

7. The gripping device as recited in claim 6, wherein the gripper arm mounting blocks are mounted on linear bearings.

8. The gripping device as recited in claim 1, wherein the device further comprises a braking device.

9. The gripping device as recited in claim 8, wherein the braking device comprises a fail-safe braking device.

10. The gripping device as recited in claim 1, wherein the gripping arms are adapted to grip articles between the gripping arms.

11. The gripping device as recited in claim 1, wherein the gripping arms include elastomeric gripping surfaces.

12. A method of gripping articles, the method comprising:
mounting a gripping device to a robotic arm end, the gripping device having a motor and a drive train adapted to operate a pair of opposing gripping arms, the drive train having at least one drive belt;
driving the drive belt with a motor; and
controlling the operation of a motor to regulate the movement of the gripping arms to grip the articles.

13. The method as recited in claim 12, wherein controlling the operation of the motor comprises controlling the operation of the motor in response to at least one feedback signal from at least one of the motor and the opposing gripping arms.

14. The method as recited in claim 12, wherein the pair of opposing gripping arms comprise flexible gripping arms, and wherein the method further comprises maintaining a gripping force provided by the flexible gripping arms on at least one of the articles.

15. The method as recited in claim 14, wherein maintaining the gripping force is practiced by means of a braking device operatively connected to the drive train.

16. A fail safe mechanism for minimizing the dropping of an article retained by a gripping device, the gripping device comprising a pair of opposing arms adapted to engage the article and a drive train adapted to translate the pair of opposing arms, the fail safe mechanism comprising:
a motor having a shaft operatively connected to the drive train; and
a braking device adapted to engage and prevent rotation of the driven shaft when deactivated;
wherein, when deactivated, the braking device prevents rotation of the motor shaft and prevents disengagement of the pair of opposing arms from the article.

17. The fail-safe mechanism as recited in claim 16, wherein the drive train comprises a drive belt, and wherein the braking device is adapted to prevent translation of the drive belt.

18. A method for minimizing the dropping of an article retained by a gripping device having a drive train and opposing arms driven by the drive train, the opposing arms adapted to engage the article, the method comprising:
energizing a braking device adapted to disengage the drive train when energized;
energizing a motor operatively connected to the opposing arms;
engaging the article between the opposing arms; and
de-energizing the braking device to prevent movement of the drive train and the opposing arms and minimize dropping of the article.

19. The method as recited in claim 18, wherein the drive chain comprise a drive belt, and wherein de-energizing the braking device comprises preventing movement of the drive belt.

20. The method as recited in claim 18, wherein de-energizing the braking device comprises removing one of electrical, pneumatic, and hydraulic power from the braking device.

21. The method as recited in claim 18, wherein the method further comprises, de-energizing the motor while de-energizing the braking device.
